(19) United States
(12) Patent Application Publication
(10) Pub. No.: US 2025/0318561 A1
(43) Pub. Date: Oct. 16, 2025

(54) FRUIT HARVESTER APPARATUS AND METHOD OF USE

(71) Applicant: AUSSIE WINE GROUP HOLDINGS PTY LTD, Stirling (AU)

(72) Inventor: Malcolm Villis, Woodside (AU)

(21) Appl. No.: 18/655,188

(22) Filed: May 3, 2024

(30) Foreign Application Priority Data
Apr. 12, 2024 (AU) 2024202404

(51) Int. Cl. A23N 15/02; A01D 46/00; A23N 15/00

(52) U.S. Cl. CPC A23N 15/025; A01D 46/28; A01D 46/285; A23N 2015/008

(57) ABSTRACT

A sorter or sorter assembly for application to a rear-conveyor fruit harvester, being one that has a primary conveyor with a downstream, rear end located towards the rear of the rear-conveyor fruit harvester, the primary conveyor configured, in use, for collecting harvested material and conveying the harvested material downstream. The sorter can improve the ability of a rear-conveyor fruit harvester to separate waste from fruit, such as berries or nuts. The sorter or sorter assembly reduces the likelihood of fruit being damaged or destroyed by the rear-conveyor fruit harvester, may reduce the amount of energy the rear-conveyor fruit harvester must expend moving waste, and may reduce the likelihood of waste clogging downstream parts of the rear-conveyor fruit harvester. Therefore, the sorter or sorter assembly may increase the fruit-to-waste ratio of harvested material, increase harvester throughput, and/or increase the value of a fruit harvest.

### CROSS-REFERENCE TO PRIOR APPLICATION

This application claims priority to Australian Patent Application No. 2024202404, filed Apr. 12, 2024, hereby expressly incorporated by reference in its entirety.

### FIELD OF THE INVENTION

The present invention relates to a sorter and/or separator for rear-conveyor fruit harvesters and method of use thereof.

### BACKGROUND

Traditionally, fruit, such as berries or nuts, were harvested by hand. However, as technology has improved, driven by the need to increase the speed of harvesting and decrease the cost, the process for harvesting fruit has become increasingly automated. Many fruits are now harvested with mechanical fruit harvesters. The most commonly used mechanical fruit harvesters are grape harvesters. Mechanical grape harvesters are used throughout the world to rapidly remove grapes from grape vines.

Mechanical fruit harvesters generally work by providing a channel through which fruit plants, such as grape vines, pass as the mechanical harvester moves along a row of the fruit plants. The harvesters have a harvesting head that sits either side of the plants and vibrates (or strikes) in a lateral direction thereby laterally shaking the plants. The harvested material (including fruit) then falls from the plants and is collected by the mechanical fruit harvester.

A first type of mechanical fruit harvester is a bucket fruit harvester. In a bucket fruit harvester, the harvested material fallen from the plants is collected into one of two continuous chains of buckets that are positioned on either side of the row of fruit plants. These chains of buckets travel in a circle from the bottom of the bucket fruit harvester where they receive the falling harvested material, to the rear of the bucket fruit harvester, to the top where they deposit the harvested material, and then down again to the bottom to receive more harvested material. From the top of the bucket fruit harvester, the harvested material may be dumped into a “chaser” or trailing collection unit.

An example of a bucket fruit harvester is a Braud™ grape harvester from New Holland™.

A second type of mechanical fruit harvester is a rear-conveyor fruit harvester. The present disclosure is concerned with this type of mechanical fruit harvester. In a rear-conveyor fruit harvester, the harvested material fallen from the plants is collected on one of two primary conveyors that are positioned on either side of the row of fruit plants. These primary conveyors move the harvested material to the rear of the rear-conveyor fruit harvester. When the harvested material passes off the end of each primary conveyor, it falls onto one of two respective rear conveyors. These rear conveyors move the harvested material diagonally upwards and outwards towards either side of the rear-conveyor fruit harvester. When the harvested material falls off the end of each rear conveyor, it falls down onto one of two respective side conveyors. These side conveyors move the harvested material diagonally upwards and forwards to the top of the rear-conveyor fruit harvester. From the top, the harvested material may be offloaded into a “chaser” or trailing collection unit via a side-arm conveyor.

U.S. Pat. No. 3,667,201 reports an example of a rear-conveyor fruit harvester.

All fruit harvesters also collect material other than fruit from the plants. This material may comprise leaves or other non-fruit parts of the plant. This material may be referred to as MOG or waste. Waste is undesirable as companies such as wineries and packing houses will typically pay less for, or even reject, harvested material with a high waste-to-fruit ratio.

Some systems have been developed to try and remove waste from harvested material before the harvested material is offloaded from a rear-conveyor fruit harvester.

For example, the Quantum rear-conveyor grape harvester from American Grape Harvesters comprises two fans. One fan sits above the downstream end of each of the rear conveyors. As the harvested material falls from the rear conveyors towards the respective side conveyors, the fans are meant to suck away the waste.

However, even with these fans, the waste-to-fruit ratio can still be high as the heavy fruit can impede the movement of the lighter waste upwards towards the fans. In fact, in some cases, waste may still be attached to the heavy fruit, making it even more resistant to the flow of air generated by the fans.

Because of the shortcomings of these fan systems, existing rear-conveyor fruit harvesters sometimes need to expend significant energy moving waste all the way from the harvested plants, up the side conveyors, to the very top of the rear-conveyor fruit harvester. This is wasted energy as moving this waste produces no value.

Furthermore, the waste that passes by the fans may clog components of rear-conveyor fruit harvesters that are further downstream. Such clogging can take valuable time to rectify.

Some existing rear-conveyor fruit harvesters have incorporated more powerful fans and a larger drop from rear conveyor to side conveyor in order to try and increase the effectiveness of the fan systems. However, more powerful fans can lead to a significant amount of valuable fruit being sucked up into the fan. Furthermore, larger drops from rear conveyor to side conveyor can lead to fruit damage and can increase the likelihood of clogging downstream—as tangled piles of harvested material can form at the bottom of a large drop.

Along with existing mechanical systems, one or more people are often required to ride along on rear-conveyor fruit harvesters in order to clear blockages and remove waste. Employing these people can be very expensive.

It is to be understood that the discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

It is desired to address or ameliorate one or more disadvantages or limitations associated with the prior art, provide a sorting assembly configured for attachment to a rear-conveyor fruit harvester, a separation assembly configured for attachment to a rear-conveyor fruit harvester, or to at least provide the public with a useful alternative.

### SUMMARY

According to a first aspect there is described a sorter, for use with a rear-conveyor fruit harvester that has a primary conveyor with a downstream, rear end located towards the rear of the rear-conveyor fruit harvester, the primary conveyor configured, in use, for collecting harvested material and conveying the harvested material downstream,
the sorter configured to be partially underneath the rear end of the primary conveyor and, in use, to collect harvested material, directly or indirectly, from the primary conveyor.

According to a further aspect there is described a sorter, for use with a rear-conveyor fruit harvester that has a primary conveyor with a downstream, rear end located towards the rear of the rear-conveyor fruit harvester, the primary conveyor configured, in use, for collecting harvested material and conveying the harvested material downstream,
the sorter configured to be partially underneath the rear end of the primary conveyor and, in use, to collect harvested material, directly or indirectly, from the primary conveyor, the sorter comprising an array of rollers that are spaced apart to provide openings that are configured, in use, to allow transit of individual pieces of fruit from the harvested material to pass downwards through the sorter but impede the transit of waste from the harvested material downwards through the sorter.

According to a further aspect there is described a rear-conveyor fruit harvester comprising
a primary conveyor with a downstream, rear end located towards the rear of the rear-conveyor fruit harvester,
a sorter located partially underneath the rear end of the primary conveyor, the sorter comprising an array of rollers that are spaced apart to provide openings, and
a rear conveyor located underneath the sorter having an upstream end and downstream end, the downstream end located above a side conveyer.

According to a further aspect, the present disclosure describes a sorting assembly configured for attachment to a rear-conveyor fruit harvester, the sorting assembly comprising
a sorter that is configured for positioning above a rear conveyor that is configured for attachment to the rear-conveyor fruit harvester, wherein at least a portion of the sorter is configured for positioning underneath a downstream, rear end of a primary conveyor of the rear-conveyor fruit harvester such that the sorter can, in use, collect harvested material, the primary conveyor configured, in use, for collecting the harvested material and conveying it off of the rear end, and
wherein the sorter comprises openings that are configured, in use, to allow transit of individual pieces of fruit from the harvested material but impede the transit of waste from the harvested material downwards through the sorter.

According to a further aspect, there is described a sorting assembly configured for attachment to a rear-conveyor fruit harvester, the sorting assembly comprising
a sorter that is configured for positioning above a rear conveyor that is configured for attachment to the rear-conveyor fruit harvester, wherein at least a portion of the sorter is configured for positioning underneath a downstream, rear end of a primary conveyor of the rear-conveyor fruit harvester such that the sorter can, in use, directly or indirectly collect harvested material from the primary conveyor, the primary conveyor positioned on the inside of the rear-conveyor fruit harvester and configured, in use, for collecting the harvested material, and
wherein the sorter comprises an array of rollers that are spaced apart to provide openings that are configured, in use, to allow transit of individual pieces of fruit from the harvested material but impede the transit of waste from the harvested material downwards through the sorter.

According to a further aspect there is described a separator, for use with a rear-conveyor fruit harvester that has a primary conveyor with a downstream rear end located towards the rear of the rear-conveyor fruit harvester, the primary conveyor positioned on the inside of the rear-conveyor fruit harvester and configured, in use, for collecting harvested material from a plant being harvested and conveying it downstream to a rear conveyer, and a diagonally ascending side conveyor having an upstream bottom end and a downstream top end, the upstream bottom end positioned underneath a downstream end of the rear conveyor,
the separator comprising a separating conveyor having a plurality of openings and a de-stemmer, the separator configured for positioning above the bottom end of the side conveyer to directly or indirectly receive harvested material from at least the rear conveyer.

According to a further aspect there is described a separator, for use with a rear-conveyor fruit harvester that has a primary conveyor with a downstream rear end located towards the rear of the rear-conveyor fruit harvester, the primary conveyor positioned on the inside of the rear-conveyor fruit harvester and configured, in use, for collecting harvested material from a plant being harvested and conveying it downstream to a rear conveyer, and a diagonally ascending side conveyor having an upstream bottom end and a downstream top end, the upstream bottom end positioned underneath a downstream end of the rear conveyor,
the separator comprising a separating conveyor having a plurality of openings and a de-stemmer, the separator configured for positioning above the bottom end of the side conveyer to directly or indirectly receive harvested material from at least the rear conveyer.

According to a further aspect there is described a rear-conveyor fruit harvester comprising
a primary conveyor with a downstream rear end located towards the rear of the rear-conveyor fruit harvester, and a rear conveyer, the primary conveyor positioned on the inside of the rear-conveyor fruit harvester and configured, in use, for collecting harvested material from a plant being harvested and conveying it downstream to the rear conveyer,
a diagonally ascending side conveyor having an upstream bottom end and a downstream top end, the upstream bottom end positioned underneath a downstream end of the rear conveyor, and
a separator comprising a separating conveyor having a plurality of openings and a de-stemmer, the separator configured for positioning above the bottom end of the side conveyer to directly or indirectly receive harvested material from at least the rear conveyer.

According to a further aspect there is described a separator configured for attachment to a rear-conveyor fruit harvester, the separator comprising
a separating conveyor comprising an upstream, intake end, a downstream, discharge end, and openings that are configured, in use, to allow transit of individual pieces of fruit from harvested material but impede the transit of waste from harvested material,
a de-stemmer that is attached to, and positioned above, the separating conveyor, and
wherein the separator is positioned above a side conveyor of the rear-conveyor fruit harvester so that, in use, the fruit transiting the separator is collected on the side conveyor.

According to a further aspect, there is described a method for retrofitting a rear-conveyor fruit harvester comprising
fitting a sorting assembly to the rear-conveyor fruit harvester, the sorting assembly comprising
   a sorter that is configured for positioning above a rear conveyor that is configured for attachment to the rear-conveyor fruit harvester, wherein at least a portion of the sorter is configured for positioning underneath a downstream, rear end of a primary conveyor of the rear-conveyor fruit harvester such that the sorter can, in use, collect harvested material from the primary conveyor, the primary conveyor configured, in use, for collecting the harvested material and conveying it downstream, and wherein the sorter comprises openings that are configured, in use, to allow transit of individual pieces of fruit from the harvested material but impede the transit of waste from the harvested material downwards through the sorter.

According to a further aspect, there is described a method for retrofitting a rear-conveyor fruit harvester comprising
fitting a separator to a rear-conveyor fruit harvester, the separator comprising
a separating conveyor comprising an upstream, intake end, a downstream, discharge end, and openings that are configured, in use, to allow transit of individual pieces of fruit from harvested material but impede the transit of waste from the harvested material,
a de-stemmer that is attached to, and positioned above, the separating conveyor,
wherein the separator is configured for positioning above a side conveyor of the rear-conveyor fruit harvester so that, in use, the fruit transiting the separating conveyor is collected on the side conveyor; and
wherein the separator is configured for, in use, receiving the harvested material
from a sorting assembly of the rear-conveyor fruit harvester.

According to a further aspect, there is described a kit comprising
a sorting assembly configured for attachment to a rear-conveyor fruit harvester, and
a separator configured for attachment to the rear-conveyor fruit harvester wherein the sorting assembly comprises
   a sorter that is configured for positioning above a rear conveyor that is configured for attachment to the rear-conveyor fruit harvester,
   wherein at least a portion of the sorter is configured for positioning underneath a downstream, rear end of a primary conveyor of the rear-conveyor fruit harvester such that the sorter can, in use, collect harvested material from the primary conveyor, the primary conveyor positioned on the inside of the rear-conveyor fruit harvester and configured, in use, for collecting harvested material, and
   wherein the sorter comprises an array of rollers that are spaced apart to provide openings that are configured, in use, to allow transit of individual pieces of fruit from the harvested material but impede the transit of waste from the harvested material, and
   wherein the separator comprises a separating conveyor comprising an upstream, intake end, a downstream, discharge end, and openings that are configured, in use, to allow transit of individual pieces of fruit but impede the transit of waste from the harvested material, and
   a de-stemmer that is attached to, and positioned above, the separating conveyor,
   wherein the separator is configured for positioning above a side conveyor of the rear-conveyor fruit harvester so that, in use, the fruit transiting the separator conveyor is collected on the side conveyor; and
   wherein the separator is configured for, in use, receiving the harvested material from the sorting assembly.

According to a further aspect, there is described a sorting assembly configured for attachment to a rear-conveyor fruit harvester, the sorting assembly comprising
a sorter that is configured for positioning above a rear conveyor that is configured for attachment to the rear-conveyor fruit harvester,
wherein at least a portion of the sorter is configured for positioning underneath a downstream, rear end of a primary conveyor of the rear-conveyor fruit harvester such that the sorter can, in use, collect harvested material from the primary conveyor, and
wherein the sorter is configured, in use, to allow transit of individual pieces of fruit from the harvested material but impede the transit of waste from the harvested material downwards through the sorter.

According to a further aspect, there is described a separator configured for attachment to a rear-conveyor fruit harvester, the separator comprising
a separating conveyor configured, in use, to allow transit of individual pieces of fruit from harvested material but impede the transit of waste from the harvested material, and
a de-stemmer that is attached to, and positioned above, the separator conveyor,
wherein the separator is configured for positioning above a side conveyor of the rear-conveyor fruit harvester so that, in use, the fruit transiting through the separating conveyor is collected on the side conveyor; and
wherein the separator is configured for, in use, receiving the harvested material from a sorting assembly of the rear-conveyor fruit harvester.

According to a further aspect, there is described apparatus for a rear-conveyor fruit harvester,
the rear-conveyor fruit harvester being one that comprises
   a primary conveyor with a downstream rear end located towards the rear of the rear-conveyor fruit harvester, the primary conveyor positioned on the inside of the rear-conveyor fruit harvester and configured, in use, for collecting harvested material from a plant being harvested and conveying it downstream to a rear conveyer, and
   a diagonally ascending side conveyor having an upstream bottom end and a downstream top end, the upstream bottom end positioned underneath a downstream end of the rear conveyor;
the apparatus comprising
(a) one or more sorters,
(b) one or more separators, or
(c) one or more sorters and one or more separators;
each of the one or more sorters defined by an array of rollers that are spaced apart to provide openings to allow transit of individual pieces of fruit from harvested material but impede the transit of waste, the array of rollers located above the rear conveyer, the rear conveyer being
   i) the rear conveyer of the rear-conveyor fruit harvester, or
   ii) a substituted rear conveyer, and
   wherein the sorter is configured such that a portion is underneath the rear end of the primary conveyor;
the one or more separators comprising
   a separating conveyor and a de-stemmer,
   wherein the separator is configured for positioning above the bottom end of the side conveyer to directly or indirectly receive harvested material from the rear conveyer, and/or from the sorter, provided the sorter is present.

According to a further aspect, there is described a method for retrofitting a rear-conveyor fruit harvester comprising:
fitting apparatus to the rear conveyor fruit harvester,
the rear-conveyor fruit harvester being one that comprises
   a primary conveyor with a downstream rear end located towards the rear of the rear-conveyor fruit harvester, the primary conveyor positioned on the inside of the rear-conveyor fruit harvester and configured, in use, for collecting harvested material from a plant being harvested and conveying it downstream to a rear conveyer, and
   a diagonally ascending side conveyor having an upstream bottom end and a downstream top end, the upstream bottom end positioned underneath a downstream end of the rear conveyor;
the apparatus comprising
(a) one or more sorters,
(b) one or more separators, or
(c) one or more sorters and one or more separators;
each of the one or more sorters defined by an array of rollers that are spaced apart to provide openings to allow transit of individual pieces of fruit from harvested material but impede the transit of waste, the array of rollers located above the rear conveyer, the rear conveyer being
   i) the rear conveyer of the rear-conveyor fruit harvester, or
   ii) a substituted rear conveyer, and
   wherein the sorter is configured such that a portion is underneath the rear end of the primary conveyor;
the one or more separators comprising
   a separating conveyor and a de-stemmer,
   wherein the separator is configured for positioning above the bottom end of the side conveyer to directly or indirectly receive harvested material from the rear conveyer, and/or from the sorter, provided the sorter is present.

The following configurations may apply to one or more of the aspects above.

In one configuration, the sorter comprises an upstream, receiving end that is configured for positioning underneath the rear end of primary conveyor and a downstream, output end, the sorter configured, in use, to move the harvested material from the receiving end towards the output end.

In one configuration, the rear-conveyor fruit harvester comprises a fan that is located above the output end of the sorter.

In one configuration, the fan is configured, in use, to draw air upwards towards the fan. The upwards drawing of air draws with it waste from the harvested material that is at, or beyond, the output end of the sorter, thereby removing this waste from the rear-conveyor fruit harvester.

In one configuration, the array of rollers spans at least part of a distance between the receiving end of the sorter and the output end of the sorter.

In one configuration, the rollers are mounted on a series of powered, rotating roller shafts. The powered rotating roller shafts are configured, in use, to rotate the rollers at a controlled speed to move the harvested material along a top of the sorter towards the output end.

In one configuration, the rollers have projections that arc radially outwards. The projections are configured, in use, to sort individual pieces of fruit within the harvested material from rest of the harvested material as it moves along the top of the sorter.

In one configuration, the output end of the sorter is configured for positioning higher than the receiving end of the sorter.

In one configuration, a portion of the sorter that is closest to the receiving end is configured for being substantially horizontal.

In one configuration, the rear conveyor comprises an upstream, inner end configured for positioning substantially underneath the receiving end of the sorter and a downstream, outer end configured for positioning substantially underneath the output end of the sorter.

In one configuration, the rear conveyor is configured, in use, to collect fruit that transits downwards through the sorter and conveys the fruit off of the outer end of the rear conveyor.

In one configuration, a vertical distance between the inner end of the rear conveyor and the receiving end of the sorter is greater than a vertical distance between the outer end of the rear conveyor and the output end of the sorter.

In one configuration, a vertical distance between the inner end of the rear conveyor and the receiving end of the sorter is at least 50 mm.

In one configuration, the rear conveyor fruit harvester comprises a diagonally ascending side conveyor with an upstream, bottom end configured for positioning substantially underneath the outer end of the rear conveyor and a downstream, top end towards the top of the rear-conveyor fruit harvester. The side conveyor is configured, in use, to receive fruit from the rear conveyor.

In one configuration, the rear conveyor fruit harvester comprises a separator comprising a separating conveyor and a de-stemmer. The separator is configured for positioning above the side conveyor so that a portion of the separator is underneath the output end of the sorter but higher than the outer end of the rear conveyor.

In one configuration, the sorter comprises an upstream, receiving end that is configured for positioning underneath the rear end of primary conveyor and a downstream, output end, the sorter configured, in use, to move the harvested material from the receiving end towards the output end.

In one configuration, the output end of the sorter is configured for positioning substantially underneath a fan that is located above the output end of the sorter.

In one configuration, the fan is part of the sorting assembly and is configured for being attached to the sorter.

In one configuration, the fan is configured, in use, to draw air upwards towards the fan, and with it waste from the harvested material that is at, or beyond, the output end of the sorter.

In one configuration, the array of rollers spans at least part of a distance between the receiving end of the sorter and the output end of the sorter.

In one configuration, at least some of the rollers are mounted on a series of powered, rotating roller shafts that are configured, in use, to rotate the rollers at a controlled speed.

In one configuration, the rollers have projections that arc radially outwards. The projections are configured, in use, to sort individual pieces of fruit within the harvested material from the rest of the harvested material as it moves along the top of the sorter.

In one configuration, the output end of the sorter is configured for positioning higher than the receiving end of the sorter.

In one configuration, a portion of the sorter that is closest to the receiving end is configured for being substantially horizontal.

In one configuration, the rear conveyor is part of the sorting assembly and is configured for being attached to the sorter.

In one configuration, the rear conveyor comprises an upstream, inner end configured for positioning substantially underneath the receiving end of the sorter and a downstream, outer end configured for positioning substantially underneath the output end of the sorter.

In one configuration, the rear conveyor is configured, in use, for collecting fruit that passes downwards through the sorter and conveying the fruit off of the outer end of the rear conveyor.

In one configuration, a vertical distance between the inner end of the rear conveyor and the receiving end of the sorter is greater than a vertical distance between the outer end of the rear conveyor and the output end of the sorter.

In one configuration, wherein a vertical distance between the inner end of the rear conveyor and the receiving end of the sorter is at least 50 mm.

In one configuration, the sorting assembly comprises one or more brackets via which the sorting assembly can be bolted onto the rear-conveyor fruit harvester.

In one configuration, the sorting assembly is configured, in use, for collecting the harvested material from a primary conveyor of the rear-conveyor fruit harvester, the primary conveyor positioned on the inside of the rear-conveyor fruit harvester and configured, in use, for collecting the harvested material from the plant being harvested.

In one configuration, a portion of the separating conveyor near the intake end is configured for positioning underneath a fan that is configured for being attached to the rear-conveyor fruit harvester.

In one configuration, the sorting assembly is configured for positioning above a rear conveyor of the rear-conveyor fruit harvester so that at least a portion of the sorting assembly is underneath a downstream, rear end of the primary conveyor.

In one configuration, the sorting assembly comprises an array of rollers that are spaced apart to provide openings. The openings are configured, in use, to allow transit of individual pieces of fruit from the harvested material but impede the transit of waste from the harvested material downwards through the sorter.

In one configuration, the intake end of the separating conveyor is configured for positioning higher than a downstream end of the rear conveyor so that it does not receive any material from the rear conveyor.

In one configuration, the separating conveyor comprises a continuous mesh belt that is mounted on an upstream shaft and a downstream shaft.

In one configuration, the separating conveyor comprises i) a substantially flat intermediate zone, ii) a ramped first zone, located upstream of the intermediate zone, iii) a ramped second zone, located downstream of the intermediate zone, or iv) any combination of (i) to (iii).

In one configuration, the separator is configured, in use, for collecting at least a portion of the harvested material from the sorting assembly on the ramped first zone.

In one configuration, the separator is configured, in use, for collecting at least a portion of the harvested material from the sorting assembly on the intermediate zone.

In one configuration, at least a portion of one or more of the ramped first zone and the intermediate zone is configured for positioning underneath the fan.

In one configuration, each de-stemming wheel comprises a series of rotating fingers extending from a powered wheel shaft. The rotating fingers are configured for, in use, de-stemming any pieces of fruit from the harvested material on the separating conveyor that are still attached to waste.

In one configuration, the separator conveyor comprises an upstream, intake end, a downstream, discharge end, and openings that are configured, in use, to allow transit of individual pieces of fruit but impede the transit of waste from the harvested material downwards through the separating conveyor.

In one configuration, the separator is configured such that, where a sorter or sorter assembly is present, the separating conveyer of the separator receives harvested material solely from the array of rollers.

In one configuration, the separator is configured so that a portion of the separator is underneath the output end of the sorter but higher than the outer end of the rear conveyor, provided the sorter and the separator are both present.

In one configuration, one or more of the output end of the sorter, provided the sorter is present, and a portion of the separating conveyor near the intake end, provided the separator is present, is configured for positioning substantially underneath a fan.

In one configuration, the fan is configured, in use, for drawing air upwards towards the fan, and with it waste from the harvested material, thereby removing this waste from the rear-conveyor fruit harvester.

In one configuration, apparatus comprises a sorting assembly comprising the sorter and one or more of the substituted rear conveyor, and the fan, provided the sorter is present.

In one configuration, the method comprises fitting the substituted rear conveyor to the rear-conveyor fruit harvester so that it is underneath the array of rollers

In one configuration, the method comprises fitting the one or more sorters to the rear-conveyor fruit harvester so that a downstream, output end of the one or more sorters is positioned substantially underneath a fan of the rear-conveyor fruit harvester.

In one configuration, the method comprises fitting the fan to the rear-conveyor fruit harvester.

In one configuration, the method comprises fitting the one or more sorters, the substituted rear conveyor, and the fan to the rear-conveyor fruit harvester as one sorting assembly.

In one configuration, the method comprises fitting the one or more sorters to the rear-conveyor fruit harvester so that a vertical distance between an upstream inner end of the rear conveyor and an upstream receiving end of the one or more sorters is greater than a vertical distance between the downstream end of the rear conveyor and the downstream output end of the one or more sorters.

In one configuration, the method comprises fitting the one or more separators to the rear conveyor fruit harvester so that a portion of the separating conveyor near an upstream intake end is positioned substantially underneath a fan of the rear-conveyor fruit harvester.

In one configuration, the method comprises fitting the one or more separators to the rear-conveyor fruit harvester so that a portion of the one or more separators is underneath a downstream, output end of the one or more sorters but higher than the downstream end of the rear conveyor, provided the one or more sorters are present.

In one configuration, the method comprises fitting both the one or more sorters and the one or more separators to the rear-conveyor fruit harvester.

The term “comprising” as used in the specification and claims means “consisting at least in part of”. When interpreting each statement in this specification that includes the term “comprising”, features other than that or those prefaced by the term may also be present. Related terms “comprise” and “comprises” are to be interpreted in the same manner.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

As used herein “(s)” following a noun means the plural and/or singular forms of the noun.

As used herein the term “and/or” means “and” or “or” or both.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

### BRIEF DESCRIPTION OF THE FIGURES

FIG. 1 is a rear view of a rear-conveyor fruit harvester of the prior art.

FIG. 2 is a rear perspective view of a rear-conveyor fruit harvester of FIG. 1.

FIG. 3 is a front schematic representation of an embodiment of the sorting assembly.

FIG. 4 is a front detailed view of an embodiment of the sorting assembly.

FIG. 5 is a front detailed view of an embodiment of the sorting assembly.

FIG. 6 is a front perspective view of an embodiment of the sorting assembly.

FIG. 7 is a left view of an embodiment of the sorting assembly.

FIG. 8 is a top view of an embodiment of the sorting assembly.

FIG. 9 is a left detailed view of an embodiment of the separator.

FIG. 10 is a front schematic view of an embodiment of the sorting assembly and an embodiment of the separator.

FIG. 11 is a front perspective view of an embodiment of the separator.

FIG. 12 is a top view of an embodiment of the separator.

FIG. 13 is a front perspective view of an embodiment of the sorting assembly.

FIG. 14 is a front perspective view of an embodiment of the sorting assembly.

FIG. 15 is a front perspective view of an embodiment of the sorting assembly.

FIG. 16 is a top view of an embodiment of the sorting assembly.

FIG. 17 is a front view of an embodiment of the sorting assembly.

FIG. 18 is a front perspective view of an embodiment of the sorting assembly.

FIG. 19 is a magnified view of a portion of an embodiment of the sorting assembly.

FIG. 20 is a bottom perspective view of an embodiment of the sorting assembly.

### DETAILED DESCRIPTION

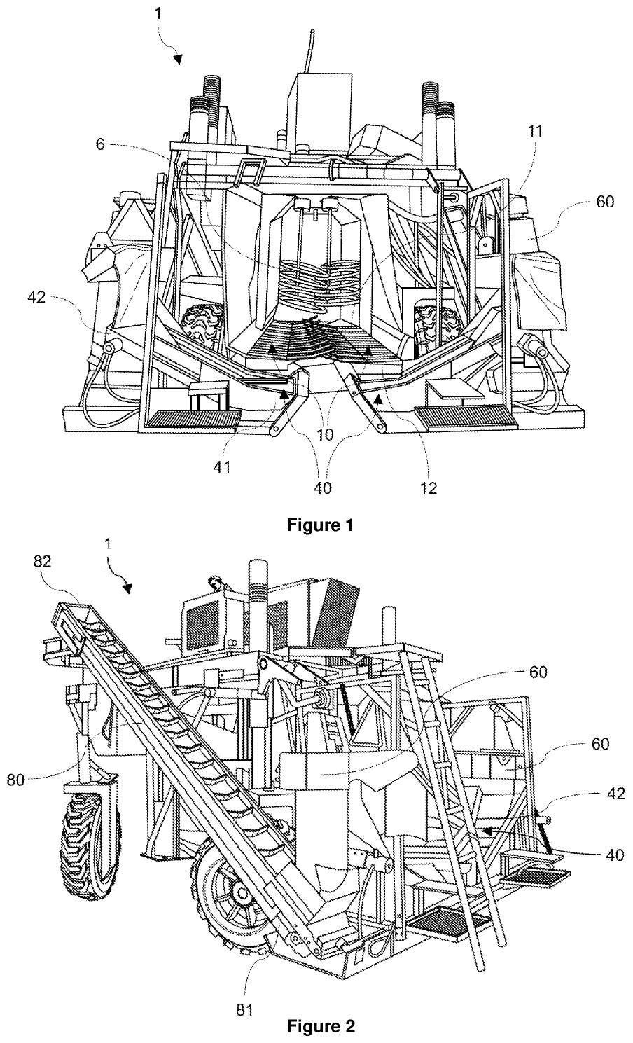

Described is a sorter or sorter assembly for application to a rear-conveyor fruit harvester, being one that has a primary conveyor with a downstream, rear end located towards the rear of the rear-conveyor fruit harvester, the primary conveyor configured, in use, for collecting harvested material and conveying the harvested material downstream. An example of such a rear-conveyor fruit harvester is shown in FIGS. 1 and 2. The sorter or sorter assembly is located partially underneath the rear end of the primary conveyor. The sorter or sorter assembly is configured, in use, for collecting the harvested material, directly or indirectly, from the primary conveyor.

The sorter or sorter assembly comprises an array of rollers that are spaced apart to provide openings.

Also described is a separator for application to a rear-conveyor fruit harvester, being one that has a primary conveyor with a downstream, rear end located towards the rear of the rear-conveyor fruit harvester (the primary conveyor configured, in use, for collecting harvested material and conveying the harvested material downstream) and a side conveyor. An example of such a rear-conveyor fruit harvester is shown in FIGS. 1 and 2. The separator is located above the side conveyor of the rear-conveyor fruit harvester. The separator enables fruit transiting through the separator to be collected on the side conveyor.

The separator comprises a separating conveyor having openings and a de-stemmer that is positioned above the separating conveyor.

Also described is a sorter/sorter assembly and separator for application to a rear-conveyor fruit harvester, being one that has a primary conveyor with a downstream, rear end located towards the rear of the rear-conveyor fruit harvester (the primary conveyor configured, in use, for collecting harvested material and conveying the harvested material downstream) and a side conveyor. An example of such a rear-conveyor fruit harvester is shown in FIGS. 1 and 2. The sorter is configured, in use, for collecting the harvested material, directly or indirectly, from the primary conveyor. The separator is located above the side conveyor of the rear-conveyor fruit harvester. The separator enables fruit transiting through the separator to be collected on the side conveyor. The sorter/sorter assembly comprises an array of rollers that are spaced apart to provide openings. The separator comprises a separating conveyor having openings and a de-stemmer that is positioned above the separating conveyor.

The present disclosure may improve the ability of a rear-conveyor fruit harvester to separate waste from fruit such as berries or nuts. The present disclosure may reduce the likelihood of fruit being damaged or destroyed by the rear-conveyor fruit harvester. The present disclosure may reduce the amount of energy the rear-conveyor fruit harvester must expend moving waste. The present disclosure may reduce the likelihood of waste clogging downstream parts of the rear-conveyor fruit harvester. Therefore, the present disclosure may increase the fruit-to-waste ratio of harvested material, increase harvester throughput, and/or increase the value of a fruit harvest.

The present disclosure provides a sorting assembly that is positioned above a rear conveyor of a rear-conveyor fruit harvester. In this way, the sorting assembly is positioned upstream (in relation to the flow of harvested material) of a fan of the rear-conveyor fruit harvester. The sorting assembly may sort some of the waste that is still attached to the harvested fruit from that fruit. The sorting assembly may also maintain a proportion of the harvested waste up above individual fruits, or at least remove a proportion of the waste from underneath individual fruits or bunches of fruits.

The use of the sorter/sorter assembly as described may allow for the waste, that reaches the end of the sorting assembly and falls underneath the fan, to be separated from the fruit, the fruit being separated from the fan by some distance. Thus, the waste may be more exposed and susceptible to the upwards flow of air generated by the fan (and comparatively the fruit is not). This increased exposure and susceptibility means that the fan may be more effective at removing the waste, thereby improving the ability of the fruit harvester to sort the waste from the fruit. Likewise the fruit is less susceptible to being removed by the fan.

Improving the effectiveness of the fan may also decrease the amount of waste that is present in the harvester processing path downstream of the fan. This means that the harvester may not have to expend as much energy moving waste to downstream separators which may be positioned on top of the harvester or outside of the harvester altogether (such as on a “chaser” or trailing collection unit). Decreasing the amount of waste that is present in the harvester processing path downstream of the fan may also reduce the likelihood of waste clogging downstream parts of the harvester.

Improving the effectiveness of the fan also means that there may be no need to compensate with an overly powerful fan or an overly large drop to the side conveyor. Therefore, the fan is less likely to suck up a significant amount of valuable fruit and the likelihood of clogging downstream is further reduced—as tangled piles of harvested material are less likely to form at the bottom of the drop.

Furthermore, because the sorter/sorter assembly maintains the harvested waste up above individual pieces of the harvested fruit, these individual pieces of fruit may be further from the fan when they pass off of the rear conveyor. Therefore, this fruit may be less susceptible to the upwards flow of air generated by the fan and may be less likely to be sucked up and destroyed by the fan.

The present disclosure additionally or alternatively provides a separator that is configured for positioning above a side conveyor of a rear-conveyor fruit harvester. In this way, the separator is positioned downstream of a rear conveyor of the rear-conveyor fruit harvester. The separator may comprise a separating conveyor with apertures, and a de-stemmer. The separator may separate some of the waste that is still attached to the harvested fruit from that fruit, and remove harvested waste from the rear-conveyor fruit harvester.

These effects may decrease the amount of waste that is present in the harvester processing path downstream of the side conveyor. This means that the harvester may not have to expend as much energy moving waste to downstream separators which may be positioned on top of the harvester or outside of the harvester altogether, and may reduce the likelihood of waste clogging downstream parts of the harvester.

Due to the above effects of the sorter/sorter assembly and the separator, use of one or more of these assemblies with a rear-conveyor fruit harvester can reduce, or even eliminate, the need for people to ride along on the rear-conveyor fruit harvester in order to clear blockages and remove waste.

Described is a rear-conveyor fruit harvester that comprises one or more sorters/sorter assembly.

Described is a rear-conveyor fruit harvester that comprises one or more separators.

Described is a rear-conveyor fruit harvester that comprises one or more sorters/sorter assembly and one or more separators.

The sorter/sorter assembly and the separator have been designed so that they may work together on a rear-conveyor fruit harvester to increase overall harvesting efficiency. For example, the separator may be positioned downstream of the sorting assembly in such a way that it does not reprocess any of the fruit that has already been sorted by the sorter/sorter assembly—but only processes fruit that still requires separation.

The terms “upstream” and “downstream”, as used throughout this specification, are not intended to be references to height or elevation. Rather, the terms are intended to indicate the direction of movement of harvested material through a mechanical fruit harvester or one or more parts of a mechanical fruit harvester.

The term “in use”, as used throughout this specification, refers to when the various machines and components described are being used to harvest fruit.

Throughout this specification, unless otherwise stated, when a feature or occurrence is described as being “at” an end, this is intended to cover the feature being at the extremity of the end or substantially at the end (i.e. near the extremity of the end).

With regards to a rear-conveyor fruit harvester, the terms “front” or “front end” refer to the end of the rear-conveyor fruit harvester that is at the front when the rear-conveyor fruit harvester is traveling in its forward direction. The terms “rear” or “rear end” refer to the opposite end of the rear-conveyor fruit harvester.

An example of a rear-conveyor fruit harvester 1 to which the sorting assembly and/or the separator of the present disclosure may be applied, is a substantially n-shaped machine that comprises four wheels (or tracks) and at least one motor. Such a rear-conveyor fruit harvester is shown in FIG. 1 and FIG. 2.

As shown in FIG. 1, this rear-conveyor fruit harvester 1 defines a channel through which fruit plants 2, such as grape vines, may pass as the rear-conveyor fruit harvester 1 moves along a row of the fruit plants 2 in use.

This rear-conveyor fruit harvester 1 comprises a harvesting head that is configured for, in use, sitting either side of the plants 2 and vibrating (or striking) in a lateral direction (i.e. a direction lateral to the length of the row) thereby laterally shaking the plants 2 and causing the harvested material 3 to fall.

This rear-conveyor fruit harvester 1 comprises two primary (or main) conveyors 10.

Each primary conveyor 10 is positioned on the inside of the rear-conveyor fruit harvester 1. One primary conveyor 10 is configured for positioning on the left side of the plants 2 in use. The other primary conveyor 10 is configured for positioning on the right side of the plants 2 in use.

Each primary conveyor 10 comprises an upstream, front end 11 towards the front of the rear-conveyor fruit harvester 1 and a downstream, rear end 12 towards the rear of the rear-conveyor fruit harvester 1.

The primary conveyors 10 are configured, in use, to collect the fallen harvested material 3 from the plant being harvested 2 and to convey it rearward and off of the rear end 12.

This rear-conveyor fruit harvester 1 further comprises two rear (or transverse) conveyors 40.

The left rear conveyor 40 comprises an upstream, inner end 41 that is towards the inside of the rear-conveyor fruit harvester 1 and is positioned underneath the rear end 12 of the left-side primary conveyor. This rear conveyor 40 also comprises a downstream, outer end 42 that is positioned towards the left side of the rear-conveyor fruit harvester 1 and is higher than the respective inner end 41.

The right rear conveyor 40 comprises an upstream, inner end 41 that is towards the inside of the rear-conveyor fruit harvester 1 and is positioned underneath the rear end 12 of the right-side primary conveyor. This rear conveyor 40 also comprises a downstream, outer end 42 that is positioned towards the right side of the rear-conveyor fruit harvester 1 and is higher than the respective inner end 41.

Each rear conveyor 40 is configured for, in use, collecting the harvested material 3 that falls off of the rear end 12 of its respective primary conveyor 10 and conveying this material sideways and off of its outer end 42.

This rear-conveyor fruit harvester 1 further comprises two diagonally ascending side conveyors 80.

The left side conveyor 80 comprises an upstream, bottom end 81 that is towards the bottom of the rear-conveyor fruit harvester 1 and is positioned underneath the outer end 42 of the left rear conveyor 40. This side conveyor 80 also comprises a downstream, top end 82 that is positioned towards the top of the rear-conveyor fruit harvester 1 and is higher than the bottom end 81.

The right side conveyor 80 comprises an upstream, bottom end 81 that is towards the bottom of the rear-conveyor fruit harvester 1 and is positioned underneath the outer end 42 of the right rear conveyor 40. This side conveyor 80 also comprises a downstream, top end 82 that is positioned towards the top of the rear-conveyor fruit harvester 1 and is higher than the bottom end 81.

Each side conveyor 80 is configured, in use, to collect the harvested material 3 that falls off of the outer end 42 of its respective rear conveyor 40 and to convey this material upwards and off of its top end 82.

This rear-conveyor fruit harvester 1 may further comprise two fans 60.

The left and right fans 60 may be positioned above the outer ends 42 of the respective rear conveyors 40 so that they are also positioned above the bottom ends 81 of the respective side conveyors 80.

Each fan 60 is configured for, in use, generating an air flow that draws lighter waste 5 from the harvested material 3 upwards into the fan 60 and off of the rear-conveyor fruit harvester 1 while, ideally, allowing the heavier fruit 4 to remain on the rear-conveyor fruit harvester 1.

This rear-conveyor fruit harvester 1 may further comprise a top conveyor 120.

The top conveyor 120 comprises an upstream, first end 121 that is towards one side of the rear-conveyor fruit harvester 1, and a downstream, second end 122 that is towards the other side of the rear-conveyor fruit harvester 1. The top conveyor 120 is positioned underneath the top ends 82 of both the left side conveyor 80 and the right side conveyor 80.

The top conveyor 120 is configured for, in use, collecting the harvested material 3 that falls off of the top ends 82 of both side conveyors 80 and conveying this material 3 sideways and off of its second end 122.

This rear-conveyor fruit harvester 1 may further comprise a side-arm conveyor 130.

The side-arm conveyor 130 comprises an upstream, harvester end 131 that is on the rear-conveyor fruit harvester 1, and a downstream, offloading end 132 that is cantilevered out away from the rear-conveyor fruit harvester 1.

The side-arm conveyor 130 is configured to, in use, collect the harvested material 3 that falls off of the second end 122 of the top conveyor 120 and to convey this material 3 off of its offloading end 132 and off of the rear-conveyor fruit harvester 1.

As described is the use of a sorting assembly 20 configured for attachment to a rear-conveyor fruit harvester 1. Such as the example rear-conveyor fruit harvester 1 shown in FIGS. 1 and 2.

The sorting assembly 20 comprises a sorter 21. The sorter 21 is configured to be positioned above a rear conveyor 40 that is configured to be attached to the rear-conveyor fruit harvester 1.

The rear conveyor 40 may be a factory-fitted rear conveyor of the rear-conveyor fruit harvester 1. Alternately, the rear conveyor 40 may part of the sorting assembly and fitted to the rear-conveyor fruit harvester 1.

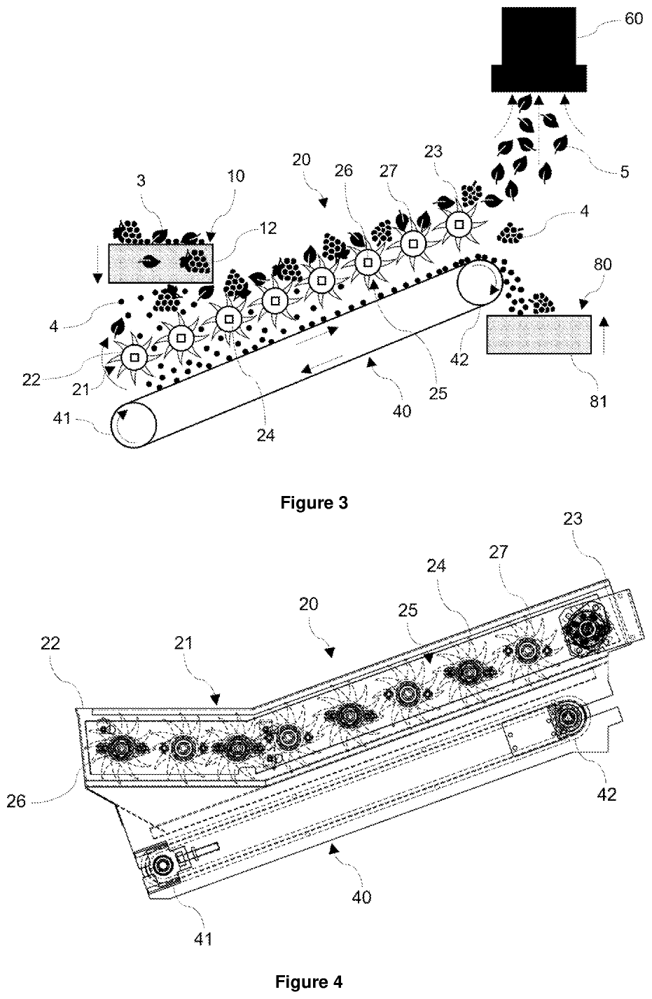

At least a portion of the sorter 21 is positioned underneath the downstream, rear end 12 of one of the primary conveyors 10 of the rear-conveyor fruit harvester 1 (as shown in FIG. 3). This positioning means that the sorter 21 can, in use, collect harvested material 3 that has fallen from the rear end 12 of the primary conveyor 10. The sorter 21 can then sort this harvested material 3 before it travels further downstream on/within the rear-conveyor fruit harvester 1.

The sorter 21 comprises an array 25 of rollers 24 (or wheels). The rollers 24 are spaced apart to provide openings 28 in between the rollers 24. The openings 28 are configured, in use, to allow transit of individual pieces of fruit 4 from the harvested material 3 through the sorter, That is, the individual pieces of fruit 4 pass downwards through the sorter 21 but the sorter impedes the transit of waste 5 from the harvested material 3 downwards through the sorter 21. The openings 28 are also configured to, in use, impede the transit of connected bunches of fruit 4 downwards through the sorter 21.

In use, individual pieces of fruit 4 that pass downwards through the sorter 21 will land on the rear conveyor 40 below.

The spacings between the rollers 24 in the array of rollers 25 may be configured so that the openings 28 are appropriate for a specific size of fruit 4. For example, the spacings for a sorter 21 for harvesting a large-diameter variety of grapes may be larger than the spacings for a sorter 21 for harvesting a small-diameter variety of grapes. Thus, spacing between the rollers 24 of the array of rollers 25 may be adjustable.

The sorter 21 comprises an upstream, receiving end 22. A portion of the sorter 21 at the receiving end 22 may be the portion of the sorter 21 that is configured for positioning underneath the rear end 12 of the primary conveyor 10. This positioning means that the receiving end 22 may be the portion of the sorter 21 that is configured for positioning underneath the rear end 12 of the primary conveyor 10.

The sorter 21 also comprises a downstream, output end 23.

The sorter 21 is configured, in use, to move (i.e. convey) the harvested material 3 from the receiving end 22 towards the output end 23. Any harvested material 3 that makes it to the output end 23 without passing downwards through the sorter 21 to the rear conveyor 40 will then be ejected off of the output end 23 and off of the sorter 21.

The array of rollers 25 spans at least part of the distance between the receiving end 22 of the sorter 21 and the output end 23 of the sorter 21. The array of rollers 25 may span the entire distance between the receiving end 22 of the sorter 21 and the output end 23 of the sorter 21.

At least some of the rollers 24 are mounted on a series of powered, rotating roller shafts 26. Power may be provided via one or more electric motors, for example. These roller shafts 26 are configured, in use, to rotate the rollers 24 at a controlled speed so that the rollers 24 move the harvested material 3 along a top of the sorter 21 towards the output end 23 (and optionally off of the output end 23).

The rollers 24 may have projections 27 that arc radially outwards. Using the projections 27, the rollers 24 are configured for sorting individual pieces of fruit 4 within the harvested material 3 from the rest of the harvested material 4 as it moves along the top of the sorter 21. That is, the rollers 24 are configured for separating individual pieces of fruit 4 within the harvested material 3 from the waste 5 that is attached to or surrounding the individual pieces of fruit 4 so that the individual pieces of fruit 4 may pass downwards through the sorter 21. Using the projections 27, the rollers 24 are also configured for keeping any of the harvested material 3 that does not pass downwards though the sorter 21 moving along a top of the sorter 21 towards the output end 23 (and off of the output end 23).

The output end 23 of the sorter 21 is configured for positioning higher than the receiving end 22 of the sorter 21. In this way, the sorter 21 is configured for ascending from the receiving end 22 to the output end 23 so that, in use, the harvested material 3 ascends as it moves along the top of the sorter 21 towards the output end 23.

As shown in FIG. 4, the portion of the sorter 21 at the receiving end 22 may be configured for being substantially horizontal. This may help to prevent the harvested material 3 moving upstream when it falls onto the sorter 21 from the primary conveyor 10.

As an alternative to the rear conveyor 40 being the factory-fitted rear conveyor 40 of the rear-conveyor fruit harvester 1, the rear conveyor 40 may instead be part of the sorting assembly 20. In this case, the rear conveyor 40 may be configured for being attached to the sorter 21 and may be configured for being fitted to the rear-conveyor fruit harvester 1 along with the sorter 21. The factory-fitted rear conveyor 40 would first need to be removed from the rear-conveyor fruit harvester 1 in order to fit a version of the sorting assembly 20 that comprises a rear conveyor 40.

Regardless of whether the rear conveyor 40 is a factory-fitted rear conveyor or a part of the sorting assembly 20, the rear conveyor 40 comprises an upstream, inner end 41 configured for positioning substantially underneath the receiving end 22 of the sorter 21 and a downstream, outer end 42 configured for positioning substantially underneath the output end 23 of the sorter 21. The rear conveyor 40 may comprise, for example, a conveyor belt.

The rear conveyor 40 is configured, in use, for collecting the fruit 4 that passes downwards through the sorter 21 and conveying that fruit 4 off of the outer end 42 of the rear conveyor 40.

The sorter 21 may be configured for the vertical distance between the inner end 41 of the rear conveyor 40 and the receiving end 22 of the sorter 21 being greater than the vertical distance between the outer end 42 of the rear conveyor 40 and the output end 23 of the sorter 21. This difference in vertical distance may be achieved, for example, as a result of the portion of the sorter 21 at the receiving end 22 being configured for being substantially horizontal.

The larger vertical distance between the inner end 41 of the rear conveyor 40 and the receiving end 22 of the sorter 21 allows more space for fruit 4 landing on the rear conveyor 40 at the inner end 41—which is where the greatest amount of fruit 4 is expected to pass downwards through the sorter 21 in use. This larger vertical distance also results in a smaller drop from the primary conveyor 10 to the sorter 21 and so reduces the likelihood of clogging downstream—as tangled piles of harvested material are less likely to form at the bottom of the smaller drop.

The vertical distance between the inner end 41 of the rear conveyor and the receiving end 22 of the sorter 21 may be in the range of 20 mm to 100 mm. For example, the vertical distance between the inner end 41 of the rear conveyor 40 and the receiving end of the sorter 21 may be in the range of 25 mm to 90 mm, in the range of 30 mm to 80 mm, in the range of 35 mm to 70 mm, in the range of 40 mm to 60 mm. The vertical distance between the inner end 41 of the rear conveyor 40 and the receiving end 22 of the sorter 21 may be 50 mm or at least 50 mm.

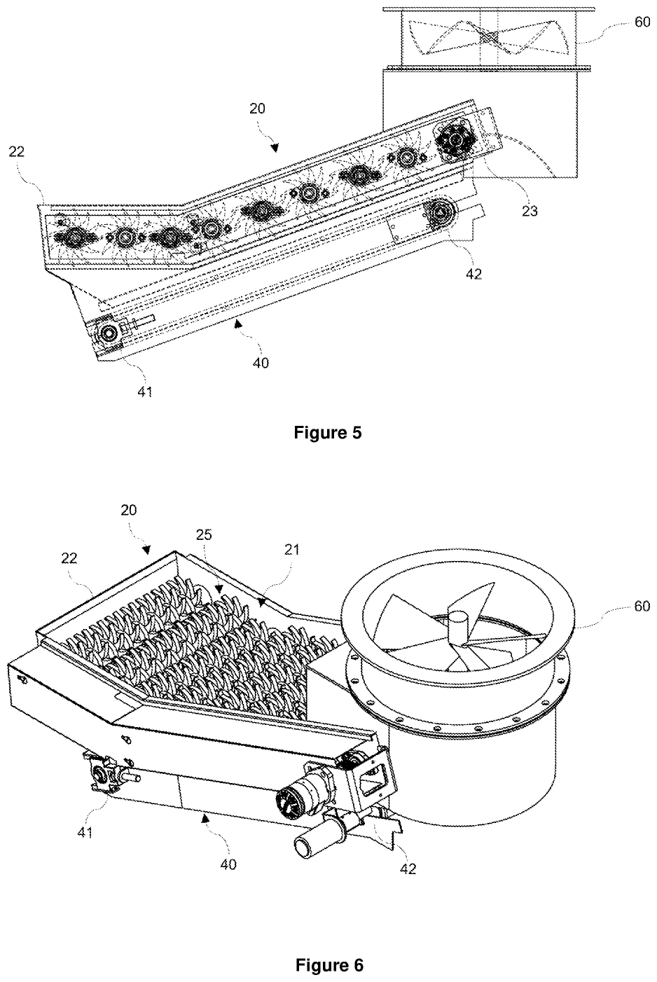

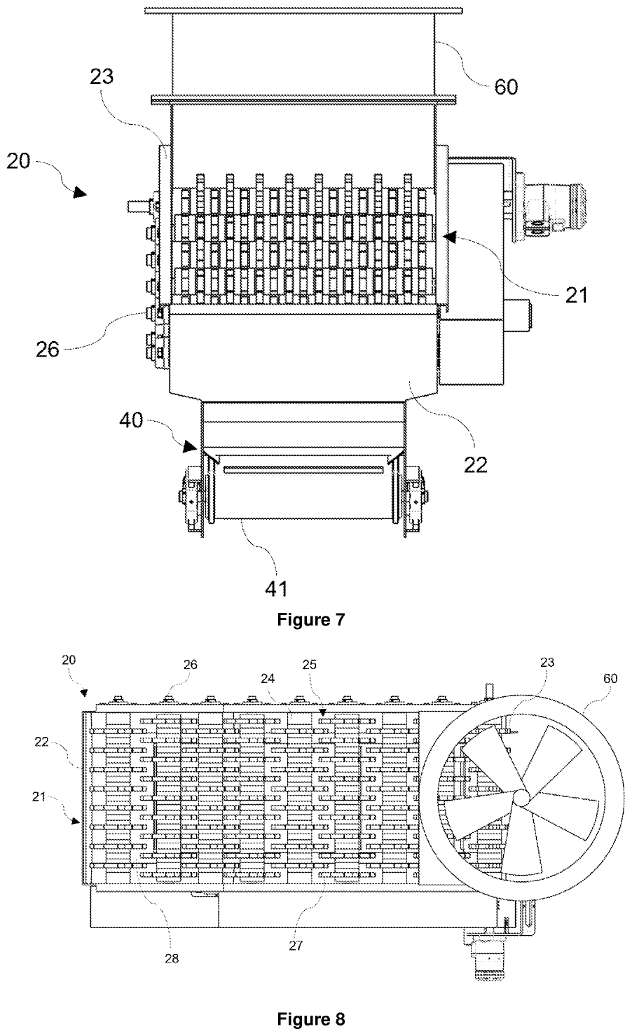

As shown in FIG. 5 to FIG. 8, the output end 23 of the sorter 21 may be configured for positioning substantially underneath a fan 60 that is configured for being attached to the rear-conveyor fruit harvester 1.

The fan 60 may be a factory-fitted fan of the rear-conveyor fruit harvester 1.

Alternatively, the fan 60 may be part of the sorting assembly 20. In this case, the fan 60 may be attached to the sorter 21 (and optionally the rear conveyor 40) and may be configured for being fitted to the rear-conveyor fruit harvester 1 along with the sorter 21 (and optionally the rear conveyor 40).

If a factory-fitted fan 60 is present, it would first need to be removed from the rear-conveyor fruit harvester 1 in order to fit a version of the sorting assembly 20 that comprises a fan 60.

The fan 60 is configured, in use, for drawing air upwards towards the fan 60, and with it waste 5 from the harvested material 3 that is at, or beyond, the output end 23 of the sorter 21, thereby removing this waste 5 from the rear-conveyor fruit harvester 1.

The sorting assembly 20 may comprise one or more brackets and/or bolt holes via which the sorting assembly 20 can be bolted onto a rear-conveyor fruit harvester 1.

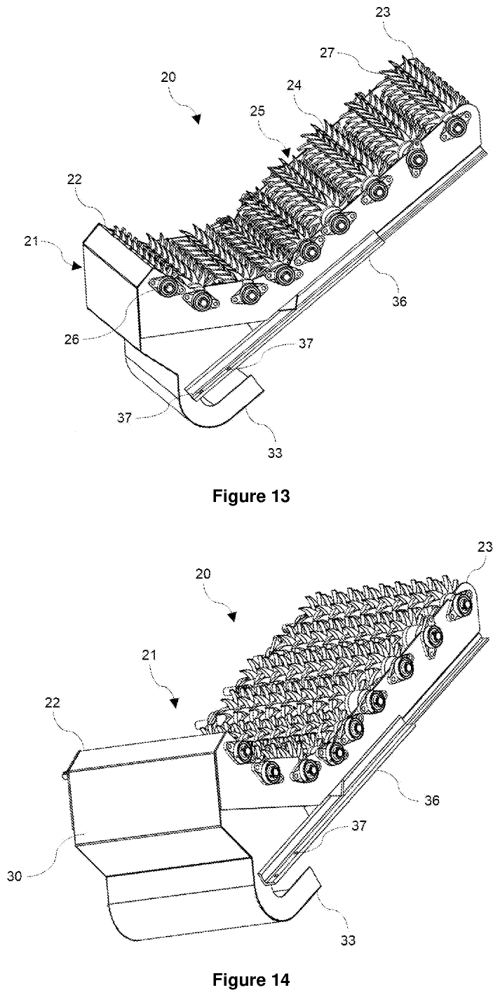

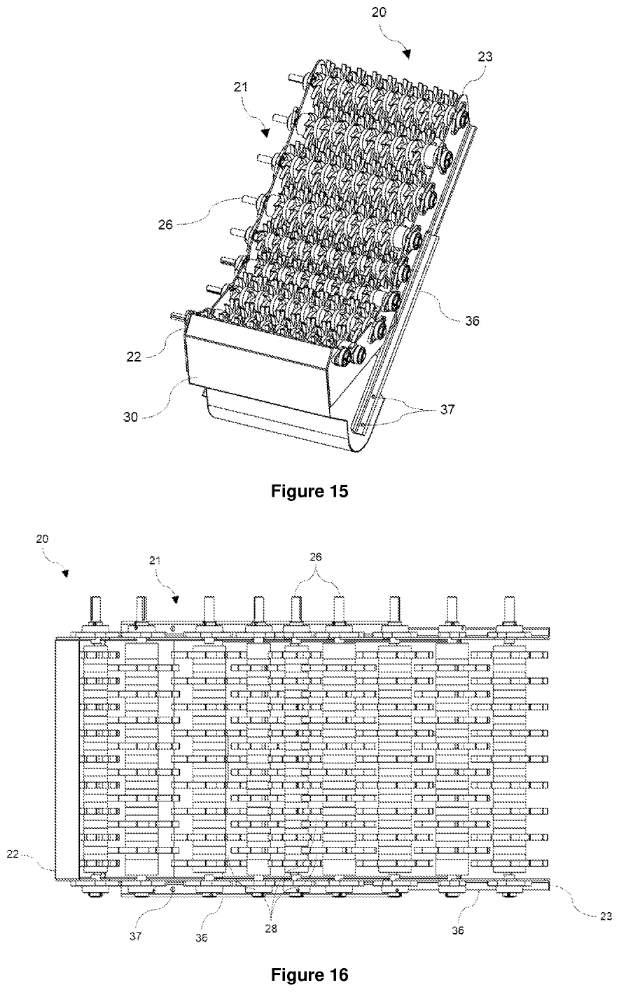

As shown in FIG. 13 to FIG. 16, the sorting assembly 20 may comprise one or more rails 36. Each of the one or more rails 36 may be attached (e.g. welded) to a side of the sorting assembly 20. Each of the one or more rails 36 may comprise a section of angle steel (or other material).

Each of the one or more rails 36 may be configured to transfer a portion of the weight of the sorting assembly 20 to the rear conveyor 40 below.

Each of the one or more rails 36 may be configured to position the sorting assembly 20 relative to the rear conveyor 40 below.

Each of the one or more rails 36 may define one or more rail bolt holes 37. Each of the one or more bolt holes 37 may be configured to receive an attachment bolt for attachment to the rear conveyor 40 below.

In this way, each of the one or more rails 36 and the corresponding attachment bolts may fix the sorting assembly 20 in position relative to the rear conveyor 40 below.

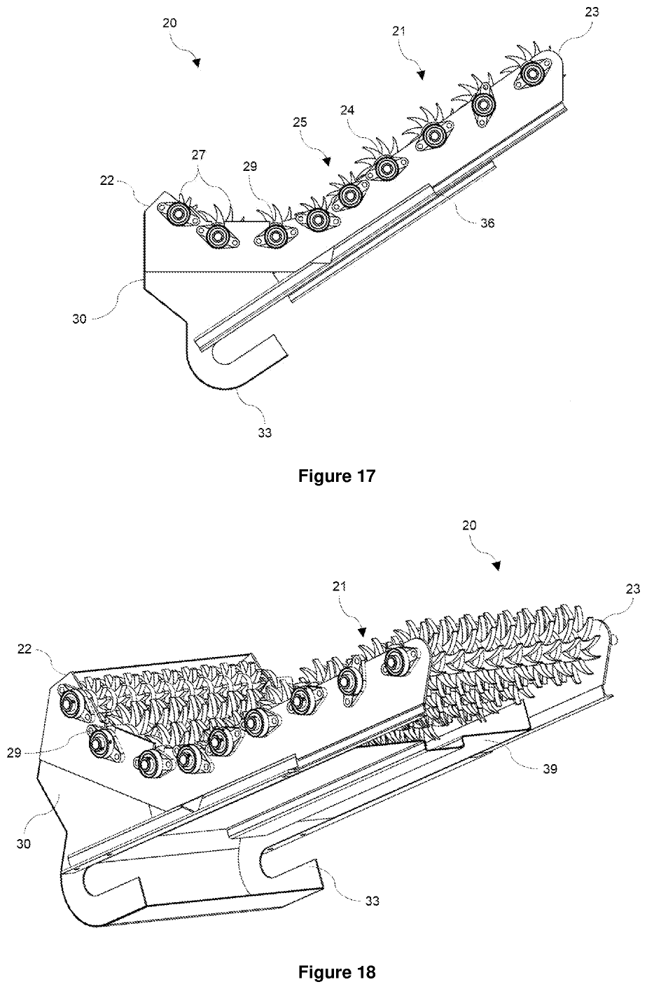

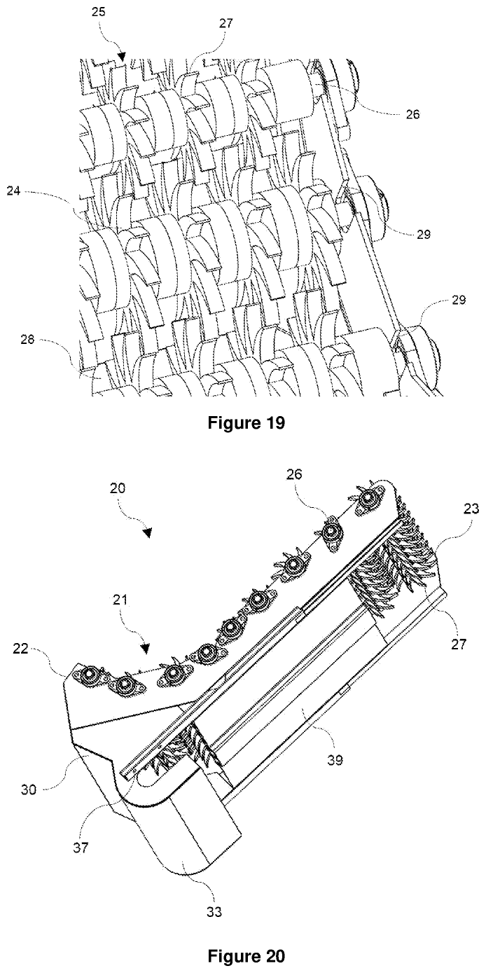

As shown in FIG. 17 to FIG. 19, each roller shaft 26 may be configured to be positioned within one or more roller shaft slots 29.

Each roller shaft slot 29 may be a slot in a panel of the sorter assembly 20 (e.g. in a panel of the sorter 21).

Each roller shaft 26 may be configured to be removable from its operative position via the opening of the one or more corresponding shaft slots 29. Therefore, it may be possible to remove individual roller shafts 26 for cleaning, maintenance, and/or replacement of the roller shaft 26, the rollers 24, and/or the projections 27. Removing individual roller shafts 26 may also allow a user to access a section of the rear conveyor 40 beneath. In some instances, this may mean that the user does not have to remove the entire sorting assembly 20 in order to access the rear conveyor 40 beneath.

As shown in FIG. 13 to FIG. 15, the receiving end 22 of the sorter 21 may comprise a receiving end casing 30.

The receiving end casing 30 may be configured to help prevent any harvested material 3 from falling off of the receiving end 22 of the sorter 21.

As mentioned above, the portion of the sorter 21 at the receiving end 22 may be configured for being substantially horizontal. Alternatively, as shown in FIG. 13, the portion of the sorter 21 at the receiving end 22 may be configured for being substantially horizontal except for the most-upstream roller shaft 26 which may be configured for being higher than that horizontal level.

This higher roller shaft 26 may help to prevent any harvested material 3 from falling off of the receiving end 22 of the sorter 21.

As shown in FIG. 18, the receiving end 22 of the sorter 21 may comprise a positioning hook 33. The positioning hook 33 may be formed from a section of the receiving end casing 30 that is curved into a hook shape.

The positioning hook 33 may be configured to hook around the inner end 41 of the rear conveyor 40. For example, the positioning hook 33 may be configured to hook around a shaft that is at the inner end 41 of the rear conveyor 40.

By hooking around the inner end 41 of the rear conveyor 40, the positioning hook 33 may be configured to position the sorting assembly 20 relative to the rear conveyor 40 below.

By hooking around the inner end 41 of the rear conveyor 40, the positioning hook 33 may be configured to help fix the sorting assembly 20 in position relative to the rear conveyor 40 below.

Fixing the sorting assembly 20 (and therefore the sorter 21) in place relative to the rear conveyor 40, can help to set and maintain a specified minimum distance between a top surface of a belt of the rear conveyor 40 and a bottom side of the array of rollers 25. Maintaining this minimum distance can help to ensure that the projections 27 of the rollers 24 do not contact the fruit 4 that is already on the rear conveyor 40. Contact between the fruit 4 that is already on the rear conveyor 40 and the projections 27 could push this fruit 4 back towards the inner end 41 of the rear conveyor 40. This could result in a decrease in throughput and even blockage.

The sorting assembly 20 may be fixed in place relative to the rear conveyor 40 so that the minimum distance between the top surface of the belt of the rear conveyor 40 and the projections is between 5 mm and 40 mm. For example, between 8 mm and 34 mm. For example, between 10 mm and 30 mm. For example, between 12 mm and 26 mm. For example, between 13 mm and 24 mm. For example, between 14 mm and 22 mm. For example, between 15 mm and 21 mm. For example, between 16 mm and 20 mm. For example, between 17 mm and 20 mm. For example, between 18 mm and 20 mm. For example, between 19 mm and 20 mm.

As shown in FIG. 20, the sorter 21 may comprise a bottom plate 39. The bottom plate 39 may be formed from one or more pieces of sheet metal. The bottom plate 39 may comprise one or more bends.

The one or more bends in the bottom plate 39 may help to prevent deformation of the bottom plate 39 in use by increasing the second moment of area of the bottom plate 39.

The bottom plate 39 may extend on a bottom side of the sorter 21.

The bottom plate 21 may be configured to support the belt of the rear conveyor 40 in use. In other words, the sorter 21 may be configured so that the belt of the rear conveyor 40 may be positioned above the bottom plate 39 and beneath the array of rollers 25.

In this way, the bottom plate 21 may support the belt of the rear conveyor 40 so that is does not droop under the weight of the fruit 4. Therefore, this support may help to prevent any steep sections forming on the belt of the rear conveyor 40—which could cause fruit 4 to roll down the rear conveyor 40.

The one or more bends in the bottom plate 39 may accommodate part of the belt of the rear conveyor 40 in use.

Also described is the use of a separator 90. This separator 90 is configured to attach to a rear-conveyor fruit harvester 1. Such as the example rear-conveyor fruit harvester 1 shown in FIGS. 1 and 2. This separator 90 may be attached to, for example, a rear-conveyor fruit harvester 1 that is intended to be used with a rear-conveyor sorting assembly (such as the sorting assembly 20 described above with regards to the first embodiment).

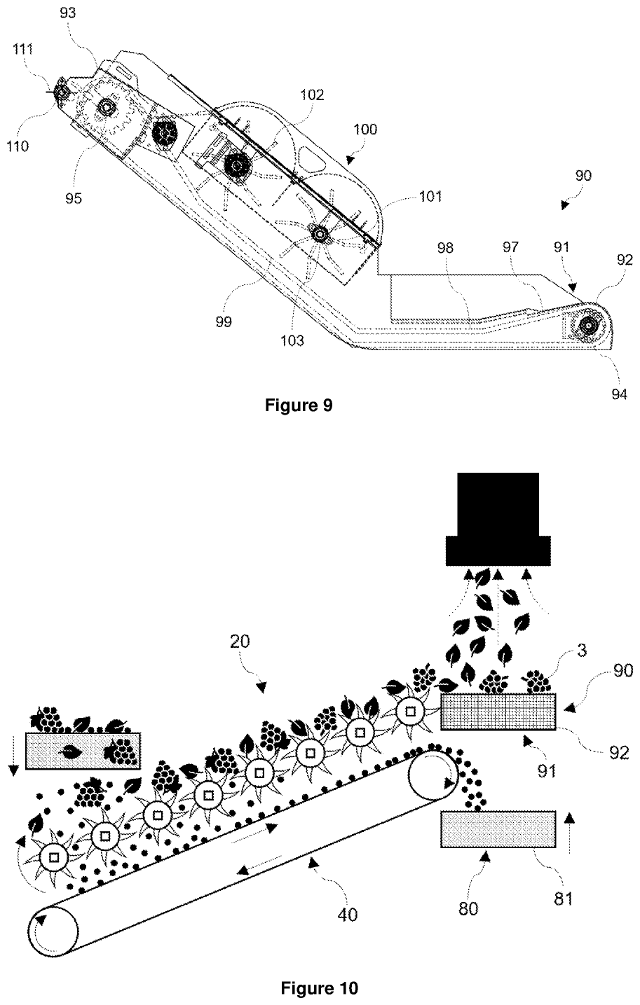

As shown in FIG. 9, the separator 90 comprises a separating conveyor 91. The separating conveyor 91 is a belt conveyor.

The separating conveyor 91 may comprise a continuous mesh belt that is mounted on an upstream shaft 94 and a downstream shaft 95. The upstream shaft 94 may be positioned at the intake end 92 of the separating conveyor 91. The downstream shaft 95 may be positioned at the discharge end 93 of the separating conveyor 91.

The separating conveyor 91 may comprise i) a substantially flat intermediate zone 98, ii) a ramped first zone 97, located upstream of the intermediate zone 98, iii) a ramped second zone 99, located downstream of the intermediate zone 98, or iv) any combination of (i) to (iii).

The separator 90 may be configured, in use, for collecting at least a portion of the harvested material 3, fallen from the sorter 21, on the ramped first zone 97. Alternatively or additionally, the separator 90 may be configured, in use, for collecting at least a portion of the harvested material, fallen from the sorter 21, on the intermediate zone 98.

At least a portion of one or more of the ramped first zone 97 and the intermediate zone 98 may be configured for positioning underneath the fan 60.

The separating conveyor 91 is configured to, in use, collect harvested material 3 fallen from a sorting assembly 20 of the rear-conveyor fruit harvester. The sorter 21 may be a sorter 21 such as that described above with regards to the first embodiment.

The separating conveyor 91 comprises an upstream, intake end 92 which is configured for positioning substantially underneath the rear conveyer 40 of a rear-conveyor fruit harvester 1, or the downstream, output end 23 of a sorter 21. The separating conveyor 91 also comprises a downstream, discharge end 93. The separating conveyor 91 also comprises apertures 96 in the belt. These apertures 96 are configured to, in use, allow transit of individual pieces of fruit 4 from the harvested material 3 to pass downwards through the separating conveyor 91 but impeding the transit of waste 5 from the harvested material 3 downwards through the separating conveyor 91.

The separator 90 may comprise a de-stemmer 100. The de-stemmer 100 may be attached to, and positioned above, a portion of the separating conveyor 91 downstream of the intake end 92. The de-stemmer 100 is configured, in use, for de-stemming any pieces of fruit 4 within the harvested material 3 on the separating conveyor 91 that are still attached to waste 5. For example, the de-stemmer 100 is configured, in use, for taking bunches of grapes and separating the individual fruits from the stems.

The de-stemmer 100 may comprise at least one de-stemming wheel 101. The de-stemming wheel 101 may comprise a series of rotating fingers 102 that extend from a powered wheel shaft 103. The rotating fingers 102 are configured, in use, for de-stemming any pieces of fruit 4 within the harvested material 3 on the separating conveyor 91 that are still attached to waste 5. For example, the rotating fingers 102 may be configured, in use, for taking bunches of grapes and separating the individual fruits from the stems.

As shown in FIG. 12, the separator 90 may comprise a rotatable clearing shaft 110. The rotatable clearing shaft 110 may be positioned next to the discharge end 93 of the separating conveyor 91. The rotatable clearing shaft 110 may comprise one or more baffles 111 that extend along the axis of the rotatable clearing shaft 110—which may be parallel to the upstream shaft 94 of the separating conveyor 91. The rotatable clearing shaft 110 may be configured for rotating so that the baffles 111 scrape any harvested material 3 left on the separating conveyor 91 off of the separating conveyor 91.

The rear-conveyor fruit harvester 1 may comprise a waste disposal system 115. At least a portion of the waste disposal system 115 may be positioned substantially underneath the discharge end 93 of the separating conveyor 91. At least a portion of the waste disposal system 115 may be positioned substantially underneath the rotatable clearing shaft 110.

The waste disposal system 115 may be in the form of a conveyor or a substantially horizontal screw/auger device. The waste disposal system 115 may be configured for collecting waste 5 that has left the discharge end 93 of the separating conveyor 91 and transporting it off of the rear-conveyor fruit harvester 1.

The separator 90 may comprise one or more brackets and/or bolt holes via which the separator can be bolted onto a rear-conveyor fruit harvester 1.

The separator 90 is configured for positioning above a side conveyor 80 of the rear-conveyor fruit harvester 1. This positioning means that, in use, fruit passing downwards through the separating conveyor is collected on the side conveyor 80.

The sorter 21, from which the separating conveyor 91 collects the harvested material 3, is configured, in use, for collecting the harvested material 3 fallen from a primary conveyor 10 of the rear-conveyor fruit harvester 1. The primary conveyor 10 is positioned on the inside of the rear-conveyor fruit harvester 1 and is configured, in use, for collecting the harvested material 3 from the plant being harvested 2 and conveying it rearward.

A portion of the separating conveyor 91 at (e.g. near) the intake end 92 may be configured for positioning substantially underneath a fan 60 that is configured for being attached to the rear-conveyor fruit harvester 1.

As shown in FIG. 10, the intake end 92 of the separating conveyor 91 is configured for positioning higher than a downstream, outer end 42 of a rear conveyor 40 of the rear-conveyor fruit harvester 1. The rear conveyor 40 is configured for positioning below the sorter 21 so that, in use, the rear conveyor 40 may collect any individual pieces of fruit 4 from the harvested material 3 that pass downwards through the sorter 21. Positioning the intake end of the separating conveyor 91 higher than the outer end of the rear conveyor 42 means that the separating conveyor 91 will not receive any of the fruit 4 that has already been sorted. Therefore, the separator 90 will not need to waste any energy or capacity reprocessing sorted fruit—and the overall throughput of the rear-conveyor fruit harvester 1 may be improved.

The separator 90 may also be configured for being attached to a rear-conveyor fruit harvester 1, such as shown in FIGS. 1 and 2. This separator 90 may be attached to, for example, a rear-conveyor fruit harvester 1 that is not intended to be used with a rear sorting assembly like the sorting assembly 20 described above with regards to the first embodiment.

The separator 90 comprises a separating conveyor 91 like that described above with regards to the second embodiment. However, in this embodiment, the separating conveyor 91 is configured for, in use, collecting harvested material 3 fallen from a rear conveyor 40 of the rear-conveyor fruit harvester 1.

In this embodiment, the separating conveyor 91 comprises an upstream, intake end 92 which is configured for positioning substantially underneath a downstream, outer end 42 of the rear conveyor 40.

The separator 90 may comprise a de-stemmer 100 like that described above with regards to the second embodiment.

The separator 90 is configured for positioning above a side conveyor 80 of the rear-conveyor fruit harvester 1. This positioning means that, in use, fruit 4 passing downwards through the separating conveyor 91 is collected on the side conveyor 80.

The rear conveyor 40, from which the separating conveyor 91 collects the harvested material 3, is configured, in use, for collecting the harvested material 3 fallen from a primary conveyor 10 of the rear-conveyor fruit harvester 1. The primary conveyor 10 is positioned on the inside of the rear-conveyor fruit harvester 1 and is configured, in use, for collecting the harvested material 3 from the plant being harvested 2 and conveying it rearward.

A portion of the separating conveyor 91 at the intake end 92 may be configured for positioning substantially underneath a fan 60 that is configured for being attached to the rear-conveyor fruit harvester 1.

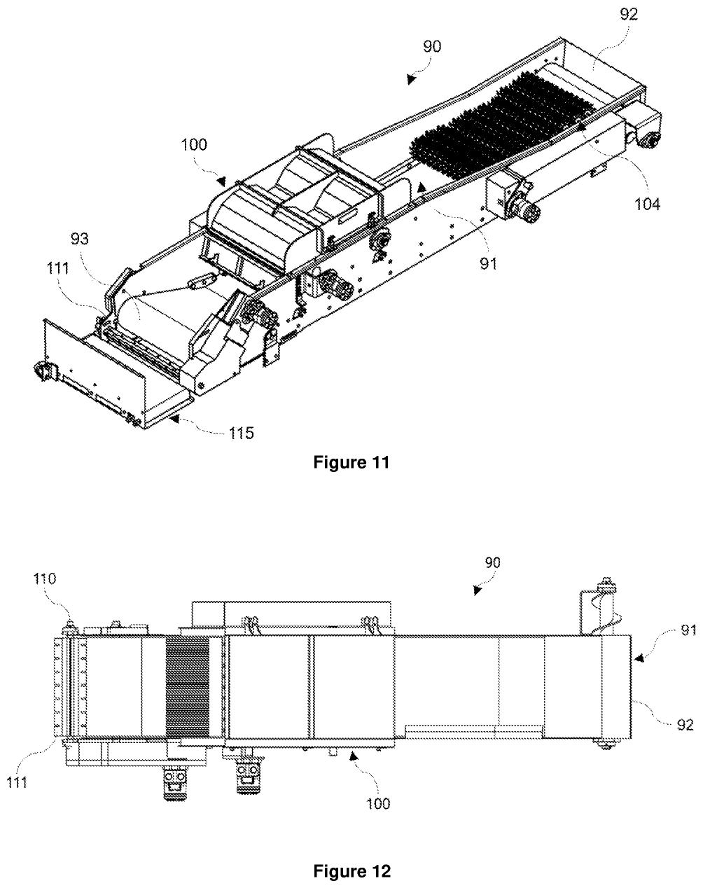

As shown in FIG. 11, in this embodiment, the separator 90 may further comprise a side sorter 104.

The side sorter 104 may have one or more of the features of the sorter 21 described above with regards to the first embodiment.

At least a portion of the side sorter 104 is configured for positioning above, at least, the intake end 92 of the separating conveyor 91, so that the side sorter 104 is upstream of the de-stemmer 100 (if present). The side sorter 104 may be configured for being attached to one or more of the separating conveyor 91 and the de-stemmer 100 (if present).

This portion of the side sorter 104 is configured for positioning substantially underneath a downstream, outer end 42 of the rear conveyor 40.

This embodiment is configured so that, the unsorted harvested material leaving the rear conveyor 40 may fall onto the side sorter 104. The individual pieces of fruit 4 that pass through the side sorter 104 will then also pass through the separating conveyor 91 and land on the side conveyor 80. The harvested material 3 that does not pass through the side sorter 104 will be moved along a top of the side sorter 104 and off of the downstream end of the side sorter 104. From here, this harvested material 3 will fall onto the separating conveyor 91 upstream of the de-stemmer 100 (if present). The separating conveyor 91 and de-stemmer 100 will then function as described above with regards to embodiment two.

The rear-conveyor fruit harvester 1 may comprise one or more of a sorter 21 and one or more of a separator 90. In this embodiment the rear-conveyor fruit harvester 1 comprises a primary conveyor 10 with a downstream, rear end 12 towards a rear of the rear-conveyor fruit harvester 1. The primary conveyor 10 is positioned on the inside of the rear-conveyor fruit harvester 1. In other words, the primary conveyor 10 is positioned underneath a top surface of the rear-conveyor fruit harvester 1.

The primary conveyor 10 is configured, in use, for collecting harvested material 3 from a plant being harvested 2 and conveying the harvested material 3 rearward and off of the rear end 12 of the primary conveyor 10.

The rear-conveyor fruit harvester 1 may comprise a sorter 21 like that described above with regards to the first embodiment.

The rear-conveyor fruit harvester 1 comprises a rear conveyor 40 that is configured, in use, for collecting any fruit 4 that has passed through the sorter 21 (if present) and conveying that fruit 4 off of the outer end 42 of the rear conveyor 40. The rear conveyor 40 may be positioned underneath the sorter 21. The rear conveyor 40 comprises an upstream, inner end 41 configured for positioning substantially underneath the rear end 12 of the primary conveyor 10 (and the receiving end 22 of the sorter 21, if present) and a downstream, outer end 42 (configured for positioning substantially underneath the output end 23 of the sorter 21, if present).

The rear-conveyor fruit harvester may comprise a fan 60. The fan 60 may be configured for positioning substantially above the outer end 42 of the rear conveyor 40. The fan 60 may be configured for positioning substantially above the output end 23 of the sorter 21 (if present).

The fan 60 is configured, in use, for drawing air upwards towards the fan 60, and with it waste 5 from the harvested material 3 that is at, or beyond, the output end 23 of the sorter 21, thereby removing this waste 5 from the rear-conveyor fruit harvester 1.

The sorter 21 (if present) may be configured for the vertical distance between the inner end 41 of the rear conveyor 40 and the receiving end 22 of the sorter 21 being greater than the vertical distance between the outer end 42 of the rear conveyor 40 and the output end 23 of the sorter 21. This difference in vertical distance may be achieved, for example, as a result of the portion of the sorter 21 at the receiving end 22 being configured for being substantially horizontal.

The larger vertical distance between the inner end 41 of the rear conveyor 40 and the receiving end 22 of the sorter 21 allows more space for fruit landing on the rear conveyor 40 at the inner end 41—which is where the greatest amount of fruit 4 is expected to pass downwards through the sorter 21 in use.

The vertical distance between the inner end 41 of the rear conveyor 41 and the receiving end 22 of the sorter 21 may be in the range of 20 mm to 100 mm. For example, the vertical distance between the inner end 41 of the rear conveyor 40 and the receiving end 22 of the sorter 21 may be in the range of 25 mm to 90 mm, in the range of 30 mm to 80 mm, in the range of 35 mm to 70 mm, in the range of 40 mm to 60 mm. The vertical distance between the inner end 41 of the rear conveyor 40 and the receiving end 22 of the sorter 21 may be 50 mm or at least 50 mm.

The rear-conveyor fruit harvester 1 comprises a side conveyor 80 like that described above.

The rear-conveyor fruit harvester 1 may comprise a separator 90 like that described above with regards to the second embodiment.

The rear-conveyor fruit harvester 1 may comprise a separator 90 like that described above with regards to the third embodiment.

The rear-conveyor fruit harvester 1 may further comprise a side-arm conveyor 130.

The side-arm conveyor 130 may comprise an upstream, harvester end 131 that is on the rear-conveyor fruit harvester 1, and a downstream, offloading end 132 that is cantilevered out away from the rear-conveyor fruit harvester 1.

The rear-conveyor fruit harvester 1 may further comprise a side-arm separator that is configured for positioning above the side-arm conveyor 130. The side-arm separator may comprise the same features and function in a similar way to the separator 90 described above with respect to the second embodiment, or the separator 90 described above with respect to the third embodiment.

The performance of a rear-conveyor fruit harvester 1 may be improved by retrofitting it with one or more of the sorting assemblies 20 described above.

The performance of a rear-conveyor fruit harvester 1 may be improved by retrofitting it with one or more of the separators 90 described above.

The performance of a rear-conveyor fruit harvester 1 may be improved by retrofitting it with one or more of the sorting assemblies 20 and one or more of the separators 90 described above.

In any of the embodiments above, where a single feature is described (such as a sorter, a sorting assembly, a separator, a fan) this feature may be applied to both sides of the rear-conveyor fruit harvester. For example, one sorter as described may be applied to a left rear conveyor, while another may be applied to a right rear conveyor of the same rear-conveyor fruit harvester. As another example, one sorting assembly as described may be applied to a rear-conveyor fruit harvester downstream of a left-side primary conveyor, while another may be applied downstream of a right-side primary conveyor of the same rear-conveyor fruit harvester. As another example, one separator as described may be applied to a left side conveyor, while another may be applied to a right side conveyor of the same rear-conveyor fruit harvester.

Although embodiments have been described with reference to a number of illustrative embodiments thereof, it will be understood by those skilled in the art that various changes in form and details may be made therein without departing from the spirit and scope of the invention as defined by the appended claims. Many modifications will be apparent to those skilled in the art without departing from the scope of the present invention as herein described with reference to the accompanying drawings.

1. Apparatus for a rear-conveyor fruit harvester,
the rear-conveyor fruit harvester being one that comprises:
a primary conveyor with a downstream rear end located towards the rear of the rear-conveyor fruit harvester, the primary conveyor positioned on the inside of the rear-conveyor fruit harvester and configured, in use, for collecting harvested material from a plant being harvested and conveying it downstream to a rear conveyor, and
a diagonally ascending side conveyor having an upstream bottom end and a downstream top end, the upstream bottom end positioned underneath a downstream end of the rear conveyor;
the apparatus comprising
a sorter extending laterally from the primary conveyor towards the diagonally ascending side conveyor,
the sorter defined by an array of rollers having projections that arc radially outwards, the rollers being spaced apart to provide openings to allow transit of individual pieces of fruit from harvested material but impede the transit of waste, the array of rollers located above a continuous rear conveyor that rotates about an upstream shaft and a downstream shaft, the rollers of sorter and the shafts of the continuous conveyor rotating in the same direction to direct harvested material from the primary conveyor laterally towards the diagonally ascending side conveyor, the rear conveyor being
i) the rear conveyor of the rear-conveyor fruit harvester, or
ii) a substituted rear conveyor that is a substitute for the rear conveyor of the rear-conveyor fruit harvester, and
wherein an upstream portion of the sorter is positioned adjacent to, or underneath, the rear end of the primary conveyor, and a downstream portion of the sorter is positioned underneath a fan.

2. The apparatus of claim 1, wherein the sorter comprises an upstream portion of the sorter is a receiving end that receives fruit from positioning underneath the rear end of the primary conveyor and the downstream portion is an output end, the sorter being configured, in use, to move harvested material from the receiving end towards the output end, and
wherein the array of rollers spans the distance between the receiving end of the sorter and the output end of the sorter.

3. (canceled)

4. The apparatus of claim 1, wherein the projections extend perpendicularly from the axis of the shaft of the roller in an arc away from the direction of rotation of the radially-extending rollers.

5. (canceled)

6. The apparatus of claim 2, wherein the sorter includes a ramped portion such that the output end of the sorter is positioned higher than the receiving end of the sorter.

7. The apparatus of 2 claim 6, wherein a portion of the sorter at the receiving end is substantially horizontal.

8. The apparatus of claim 2, wherein the rear conveyor comprises an upstream, inner end configured for positioning substantially underneath the receiving end of the sorter and a downstream, outer end configured for positioning substantially underneath the output end of the sorter, and
wherein the rear conveyor is configured, in use, for collecting fruit that transits downwards through the sorter and conveying the fruit off of the outer end of the rear conveyor.

9. (canceled)

10. The apparatus of claim 1, comprising one or more separators, each separator comprising a separating conveyor and a de-stemmer,
wherein the separator is configured for positioning above the bottom end of the side conveyor to directly or indirectly receive harvested material from the rear conveyor, and/or from the sorter.

11. The apparatus of claim 8, wherein a vertical distance between the inner end of the rear conveyor and the receiving end of the sorter is at least 50 mm.

12. The apparatus of claim 10, wherein the separator conveyor comprises an upstream, intake end, a downstream, discharge end, and apertures that are configured, in use, to allow individual pieces of fruit from harvested material to transit downwards through the separating conveyor but impede the transit of waste from the harvested material downwards through the separating conveyor.

13. The apparatus of claim 12, wherein the separator is configured so that a portion of the separator is underneath the output end of the sorter but higher than the outer end of the rear conveyor.

14. (canceled)

15. The apparatus of claim 13, wherein the fan is configured, in use, for drawing air upwards towards the fan, and with it waste from the harvested material, thereby removing this waste from the rear-conveyor fruit harvester.

16. The apparatus of claim 1, comprising a sorting assembly comprising the sorter and one or more of the substituted rear conveyor and the fan.

17. A method for retrofitting a rear-conveyor fruit harvester comprising:
fitting an apparatus to the rear-conveyor fruit harvester,
the rear-conveyor fruit harvester being one that comprises a primary conveyor with a downstream rear end located towards the rear of the rear-conveyor fruit harvester, the primary conveyor positioned on the inside of the rear-conveyor fruit harvester and configured, in use, for collecting harvested material from a plant being harvested and conveying it downstream to a rear conveyor, and
a diagonally ascending side conveyor having an upstream bottom end and a downstream top end, the upstream bottom end positioned underneath a downstream end of the rear conveyor;
the apparatus comprising
a sorter extending laterally from the primary conveyor towards the diagonally ascending side conveyor,
the sorter defined by an array of rollers having projections that arc radially outwards, the rollers being spaced apart to provide openings to allow transit of individual pieces of fruit from harvested material but impede the transit of waste, the array of rollers located above a continuous rear conveyor that rotates about an upstream shaft and a downstream shaft, the rollers of the sorter and the shafts of the continuous conveyor rotating in the same direction to direct harvested material from the primary conveyor laterally towards the diagonally ascending side conveyor, the rear conveyor being
i) the rear conveyor of the rear-conveyor fruit harvester, or
ii) a substituted rear conveyor that is a substitute for the rear conveyor of the rear-conveyor fruit harvester, and
wherein an upstream portion of the sorter is positioned adjacent to, or underneath, the rear end of the primary conveyor, and a downstream portion of the sorter is positioned underneath a fan.

18. The method of claim 17, comprising fitting the rear conveyor or the substituted rear conveyor to the rear-conveyor fruit harvester so that it is underneath the array of rollers.

19. The method of claim 17, comprising fitting the sorter to the rear-conveyor fruit harvester so that a downstream, output end of the sorter is positioned substantially underneath a fan of the rear-conveyor fruit harvester.

20. The method of claim 19, comprising fitting the fan to the rear-conveyor fruit harvester.

21. The method of claim 19, comprising fitting the sorter, the rear conveyor or the substituted rear conveyor, and the fan to the rear-conveyor fruit harvester as one sorting assembly.

22. (canceled)

23. The method of claim 17, comprising fitting one or more separators to the rear conveyor fruit harvester, the one or more separators comprising a separating conveyor and a de-stemmer, wherein the separator is positioned above the bottom end of the side conveyor to directly or indirectly receive harvested material from the rear conveyor, and/or from the sorter, so that a portion of the separating conveyor near an upstream intake end is positioned substantially underneath a fan of the rear-conveyor fruit harvester.

24. The method of claim 23, comprising fitting the one or more separators to the rear-conveyor fruit harvester so that a portion of the one or more separators is underneath a downstream, output end of the one or more sorters but higher than the downstream end of the rear conveyor, provided the one or more sorters are present.

25. (canceled)

26. The apparatus of claim 1, wherein the shafts are spaced along a plane at an orientation and distance relative to one or more adjacent shafts such that a radially-extending roller on a shaft extends into a space provided between two adjacent radially-extending rollers on an adjacent shaft to provide an array of rollers and a plurality of openings.
